(19) United States
(12) Patent Application Publication
(10) Pub. No.: US 2023/0413724 A1
(43) Pub. Date: Dec. 28, 2023

(54) STEERING MECHANISM OF RIDING LAWN MOWER

(71) Applicant: NINGBO LINGYUE INTELLIGENT EQUIPMENT CO.,LTD, Ningbo City (CN)

(72) Inventors: Shengqiu Zhu, Ningbo City (CN); Baijun Tong, Ningbo City (CN); Shulin Peng, Ningbo City (CN); Jiafeng Xuan, Ningbo City (CN); Wenming Wu, Ningbo City (CN); Xiaobo Ye, Ningbo City (CN)

(21) Appl. No.: 17/975,569

(22) Filed: Oct. 27, 2022

(30) Foreign Application Priority Data
Jun. 27, 2022 (CN) 202210732874.0
Jun. 27, 2022 (CN) 202221625745.3

(51) Int. Cl. A01D 34/00; B62D 7/14

(52) U.S. Cl. CPC A01D 34/00; B62D 7/142; A01D 2101/00

(57) ABSTRACT

The present disclosure relates to a steering mechanism of a riding lawn mower, which comprise: a steering shaft, one end of which is connected with a steering wheel, and the other end of which is rotatably connected with a frame, wherein a steering gear is coaxially provided; a steering plate, which is rotatably connected to the frame and is provided with an arc-shaped tooth part engaged with the steering gear, wherein the center of a circle of the arc-shaped tooth part is located at the rotating center of the steering plate; a first steering knuckle and a second steering knuckle, which are rotatably connected to the frame and rotate synchronously with respect to the frame through a linkage structure; a steering knuckle arm, which is connected with the first steering knuckle and rotates synchronously with respect to the frame; and a connecting rod, one end of which is hinged with one end of the steering plate far away from the arc-shaped tooth part, and the other end of which is hinged with the rotating distal end of the steering knuckle arm. As such, the pure mechanical structure combination of the steering wheel, the steering shaft, the steering plate, the connecting rod and the steering knuckle arm is used, which directly transmits the rotary operation of the steering wheel to a turning wheel, so as to realize steering. The steering mechanism is simple and compact in structure, high in reliability and low in cost.

### TECHNICAL FIELD

The present disclosure relates to the technical field of a mechanical steering system, in particular to a steering mechanism of a riding lawn mower.

### BACKGROUND

A mechanical steering system uses the physical strength of a driver as a steering energy, in which all the force transmission parts are mechanical. The mechanical steering system consists of a steering control mechanism, a diverter and a steering transmission mechanism.

A riding lawn mower, which is also referred to as a riding lawn machine, is a large mechanical tool for mowing lawns and vegetation and is widely used in real life. The application of a lawn mower not only saves a lot of labor time, but also makes the lawn more beautiful after being mowed, which is a very practical mechanical tool. The mower belongs to a riding garden lawn mower, which has the characteristics of a low speed, a low torque and a small volume. If a traditional steering system is used, the traditional steering system takes up a lot of space and is expensive and not suitable for the mower.

### SUMMARY

In order to at least overcome the problems existing in related technologies to a certain extent, the purpose of the present disclosure is to provide a steering mechanism of a riding lawn mower, which has the advantages of being simple and compact in structure, high in reliability and low in cost. Many technical effects that can be produced by the preferred technical scheme among the technical schemes provided by the present disclosure are described in detail in the following description.

The present disclosure provides a steering mechanism of a riding lawn mower, comprising:
a steering shaft, one end of which is connected with the steering wheel, and the other end of which is rotatably connected with the frame, wherein a steering gear is coaxially provided;
a steering plate, which is rotatably connected to the frame, wherein the steering plate is provided with an arc-shaped tooth part engaged with the steering gear, and the center of a circle of the arc-shaped tooth part is located at the rotating center of the steering plate;
a first steering knuckle and a second steering knuckle, which are rotatably connected to the frame and rotate synchronously with respect to the frame through a linkage structure;
a steering knuckle arm, which is connected with the first steering knuckle and rotates synchronously with respect to the frame;
a connecting rod, one end of which is hinged with one end of the steering plate far away from the arc-shaped tooth part, and the other end of which is hinged with the rotating distal end of the steering knuckle arm.

Preferably, the linkage structure comprises:
a first linkage arm, which is connected with the first steering knuckle 6 and rotates synchronously with respect to the frame;
a second linkage arm, which is connected with the second steering knuckle 10 and rotates synchronously with respect to the frame;
a tie rod, both ends of which are hinged with the rotating distal ends of the first linkage arm and the second linkage arm, respectively.

Preferably, the frame is provided with a first steering sleeve and a second steering sleeve, the first steering knuckle is rotatably connected to the first steering sleeve through a first rotating shaft, and the second steering knuckle is rotatably connected to the second steering sleeve through a second rotating shaft.

Preferably, the steering knuckle arm and the first linkage arm are both connected with the first rotating shaft and are located at both ends of the first steering sleeve, respectively.

Preferably, the steering shaft is obliquely provided with respect to the plane where the steering plate is located, and the steering gear is provided as a helical gear.

Preferably, the steering gear is provided as a spiral cylindrical gear, and the arc-shaped tooth part is provided as an involute gear.

Preferably, a limiting structure for limiting the rotation angle of the steering plate is provided between the steering plate and the frame.

Preferably, the limiting structure comprises a chute and a slider provided in the chute slidably, one of the chute and the slider is provided on the frame and the other thereof is provided on the steering plate, and the chute is provided in an arc shape with the rotating center of the steering plate as a circle.

Preferably, the steering gear is mounted on the frame through a pressing plate.

Preferably, both ends of the tie rod are connected with the first linkage arm and the second linkage arm through a ball connection structure.

The technical scheme provided by the present disclosure can include the following beneficial effects.

When a vehicle is steering, the steering torque applied by a driver to the steering wheel is output to the steering gear through the steering shaft, and then is output to the steering plate through the arc-shaped tooth part. After the arc-shaped tooth part amplifies the torque and decelerates, the steering plate rotates to drive the pull rod to move and pull the steering knuckle arm to rotate. At the same time, the first steering knuckle and the second steering knuckle rotate synchronously under the action of the linkage structure, so that the left and right turning wheels deflect synchronously. The present disclosure is simple in structure, light in weight, easy to manufacture, low in cost, high in transmission efficiency, and sensitive to steering, and does not need to adjust the meshing clearance. Because the steering transmission structure is simplified, the present disclosure is very suitable for a riding lawn mower, which has the characteristics of being low in speed, low in torque, small in volume and light in weight.

It should be understood that the above general description and the following detailed description are exemplary and explanatory only, and do not limit the present disclosure.

### BRIEF DESCRIPTION OF THE DRAWINGS

The drawings herein are incorporated into and constitute a part of the specification, illustrate embodiments consistent with the present disclosure, and together with the specification, serve to explain the principle of the present disclosure.

In order to explain the embodiments of the present disclosure or the technical schemes in the prior art more clearly, the drawings that need to be used in the description of the embodiments or the prior art will be briefly introduced hereinafter. Obviously, the drawings in the following description are only some embodiments of the present disclosure. For those skilled in the art, other drawings can be obtained according to these drawings without any creative effort.

FIG. 1 is a perspective view of a steering mechanism of a riding lawn mower according to some exemplary embodiments.

FIG. 2 is a top view of a steering mechanism of a riding lawn mower according to some exemplary embodiments.

FIG. 3 is a transmission connection structure diagram of a steering shaft and a steering plate according to some exemplary embodiments.

FIG. 4 is a connection structure diagram of a steering shaft and a frame according to some exemplary embodiments.

In the figures: 1, steering wheel; 2, steering shaft; 3, steering plate; 4, connecting rod; 5, steering knuckle arm; 6, first steering knuckle; 7, first linkage arm; 8, tie rod; 9, second linkage arm; 10, second steering knuckle; 11, steering gear; 12, chute; 13, frame; 14, pressing plate.

### DETAILED DESCRIPTION OF THE EMBODIMENTS

Exemplary embodiments will be described in detail herein, examples of which are shown in the drawings. When the following description refers to the drawings, unless otherwise indicated, the same numbers in different drawings indicate the same or similar elements. The embodiments described in the following exemplary embodiments do not represent all the embodiments consistent with the present disclosure. On the contrary, the embodiments are only examples of devices or methods consistent with some aspects of the present disclosure.

In order to make the object, technical scheme and advantages of the present disclosure clearer, the technical scheme of the present disclosure will be described in detail hereinafter. Obviously, the described embodiments are only part of the embodiments of the present disclosure, rather than all of the embodiments. Based on the embodiment of the present disclosure, all other embodiments obtained by those skilled in the art without any creative effort belong to the scope of protection of the present disclosure.

Hereinafter, embodiments will be described with reference to the drawings. In addition, the following embodiments do not limit the present disclosure described in the claims. In addition, the entire contents of the structures shown in the following embodiments are not limited to those necessary for the scheme of the present disclosure described in the claims.

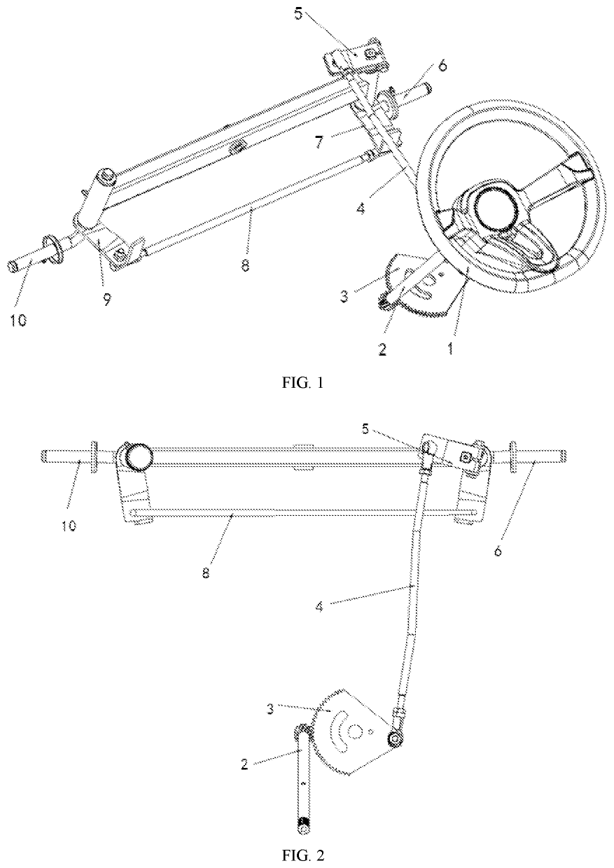

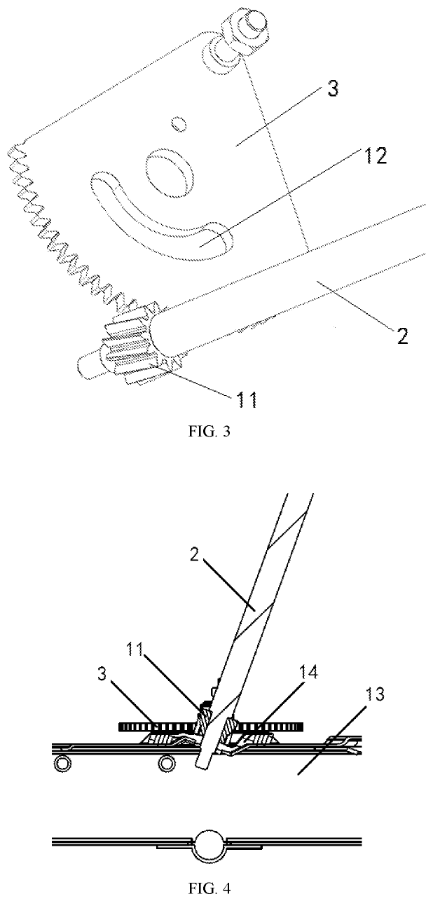

As shown in FIGS. 1-4, the detailed description provides a steering mechanism of a riding lawn mower, comprising a steering shaft 2, a steering plate 3, a first steering knuckle 6, a second steering knuckle 10, a steering knuckle arm 5 and a connecting rod 4.

One end of the steering shaft 2 is connected with the steering wheel 1, and the other end thereof is rotatably connected with the frame 13. By turning the steering wheel 1, the steering shaft 2 can be driven to rotate with respect to the frame 13. In addition, the outer periphery of the steering shaft 2 is coaxially provided with a steering gear 11 for transmitting the action of the steering shaft 2 to the steering plate 3.

The steering plate 3 is rotatably connected to the frame 13. Specifically, the middle of the steering plate 3 is rotatably connected to the frame 13 through a rotating shaft. One side of the steering plate 3 close to the steering shaft 2 is provided with an arc-shaped tooth part, which is engaged with the steering gear 11. The center of a circle of the arc-shaped tooth part is located at the rotating center of the steering plate 3. Through the structure of the steering gear 11 and the arc-shaped tooth part, the steering shaft 2 can drive the steering plate 3 to rotate.

Specifically, the steering plate 3 is provided as a sector plate. The arc-shaped tooth part is formed on the arc side of the sector plate. The middle of the sector plate is rotatably connected with the frame 13 through a rotating shaft, and the corner of the sector plate far away from the arc side is hinged with the connecting rod 4, so that the rotation of the sector plate can pull the pull rod to move.

The first steering knuckle 6 and the second steering knuckle 10 are rotatably connected to the frame 13, and are used to control two turning wheels on both sides of the frame 13 to steer, respectively. Moreover, the first steering knuckle 6 and the second steering knuckle 10 rotate synchronously with respect to the frame 13 through a linkage structure, so that the rotation direction and the rotation amplitude of the first steering knuckle 6 and the second steering knuckle are the same, and the stability of the synchronous rotation of the two turning wheels can be ensured.

The steering knuckle arm 5 is connected with the first steering knuckle 6 and rotates synchronously with respect to the frame 13. One end of the connecting rod 4 is hinged with one end of the steering plate 3 far away from the arc-shaped tooth part, and the other end thereof is hinged with the rotating distal end of the steering knuckle arm 5. Here, one end of the steering knuckle arm 5 is connected with the first steering knuckle 6, and the other end thereof is hinged with the connecting rod 4. Correspondingly, the rotating distal end of the steering knuckle arm 5 is one end of the steering knuckle arm 5 far away from the first steering knuckle 6, so that the pull rod can pull the steering knuckle arm 5 to rotate, thereby driving the first steering knuckle 6 to rotate and the second steering knuckle 10 to rotate, and driving the two wheels to steer. In this way, two steering knuckles can be driven to rotate by driving the steering knuckle arm 5 to rotate through a pull rod, which is simple in structure and high and stable in transmission synchronization.

When a vehicle is steering, the steering torque applied by a driver to the steering wheel 1 is output to the steering gear 11 through the steering shaft 2, and then is output to the steering plate 3 through the arc-shaped tooth part. After the arc-shaped tooth part amplifies the torque and decelerates, the steering plate 3 rotates to drive the pull rod to move and pull the steering knuckle arm 5 to rotate. At the same time, the first steering knuckle 6 and the second steering knuckle 10 rotate synchronously under the action of the linkage structure, so that the left and right turning wheels deflect synchronously.

It can be understood that in order to ensure that the steering wheel 1 rotates in the same direction as the turning wheel, as shown in FIG. 2, when the steering wheel 1, the steering shaft 2 and the steering plate 3 are located behind the first steering knuckle 6 and the second steering knuckle 10, the first end of the steering knuckle arm 5 is connected with the first steering knuckle 6, and the second end of the steering knuckle arm is hinged with a pull rod, wherein the second end of the steering knuckle arm 5 should be located on the left side of the first end, that is, the pull rod is located on the left side of the rotating center of the steering knuckle arm 5.

As such, the pure mechanical structure combination of the steering wheel 1, the steering shaft 2, the steering plate 3, the connecting rod 4 and the steering knuckle arm 5 is used, which directly transmits the rotary operation of the steering wheel 1 to a turning wheel, so as to realize steering. The steering mechanism is simple and compact in structure, high in reliability and low in cost.

In some embodiments, the linkage structure comprises a first linkage arm 7, a second linkage part and a tie rod 8.

The first linkage arm 7 is connected with the first steering knuckle 6 and rotates synchronously with respect to the frame 13. The second linkage arm 9 is connected with the second steering knuckle 10 and rotates synchronously with respect to the frame 13. Both ends of the tie rod 8 are hinged with the rotating distal ends of the first linkage arm 7 and the second linkage arm 9, respectively. Here, the rotating distal end of the second linkage arm is the end far away from the second steering knuckle.

In this way, while the steering knuckle arm 5 drives the first steering knuckle 6 to rotate, the first steering knuckle 6 and the first linkage arm 7 rotate synchronously. The first linkage arm 7 drives the second linkage arm 9 to rotate through the tie rod 8, thus driving the second steering knuckle 10 to rotate, so that the first steering knuckle 6 and the second steering knuckle 10 rotate synchronously.

It can be understood that in order to make the first steering knuckle 6 and the second steering knuckle 10 rotate in the same direction, the first linkage arm 7 and the second linkage arm 9 are both located on the same side of the tie rod 8. In order to make the first steering knuckle 6 and the second steering knuckle 10 rotate in the same amplitude, the length of the first linkage arm 7 is equal to that of the second linkage arm 9, that is, the connecting distance between the tie rod and the first steering knuckle on the first linkage arm is equal to the connecting distance between the tie rod and the second steering knuckle on the second linkage arm. At the same time, the first linkage arm, the second linkage arm and the tie rod encircle a parallelogram.

Specifically, both ends of the tie rod 8 are connected with the first linkage arm 7 and the second linkage arm 9 through a ball connection structure, so that the tie rod 8 has stronger transmission adaptability and more stable structure.

As shown in FIG. 1, the frame 13 is provided with a first steering sleeve and a second steering sleeve, the first steering knuckle 6 is rotatably connected to the first steering sleeve through a first rotating shaft, and the second steering knuckle 10 is rotatably connected to the second steering sleeve through a second rotating shaft. In this way, the connection area between the steering knuckle and the frame 13 can be increased through the rotary connection form of the sleeve and the rotating shaft. The longitudinal stability of the steering knuckle during rotation can be improved because both the rotating shaft and the sleeve extend longitudinally.

Further, the steering knuckle arm 5 and the first linkage arm 7 are both connected with the first rotating shaft and are located at both ends of the first steering sleeve, respectively. That is, the steering knuckle arm 5 is connected to the upper end of the first steering shaft 2, and the first linkage wall and the first steering knuckle 6 are connected to the lower end of the first steering shaft 2, so that the connecting rod 4 and the tie rod 8 are spaced at a certain distance, preventing the mutual influence of the two linkage relationships.

In some embodiments, the steering shaft 2 is obliquely provided with respect to the plane where the steering plate 3 is located, and the steering gear 11 is provided as a helical gear.

In the process of assembly and use, there is a certain angle between the steering gear 11 and the steering plate 3 in the axial direction, which is 6-10 degrees. In order to ensure the normal meshing between the gears, the steering plate 3 needs to be bent at a certain angle, so that the manufacturing cost greatly increases, and the mounting space also needs to be increased.

In this scheme, the steering gear 11 is provided as a helical gear. The inclination angle is matched with the inclination angle of the steering gear 11 with respect to the steering plate 3, so that the meshing coincidence degree between the steering gear 11 and the arc-shaped tooth part can be improved, the steering operation can be stable, and the impact and noise can be reduced.

Specifically, the steering gear 11 is provided as a spiral cylindrical gear, and the arc-shaped tooth part is provided as an involute gear.

In order to improve the mounting stability of the steering gear 11, the steering gear 11 is mounted on the frame 13 through a pressing plate 14.

In some preferred schemes, a limiting structure for limiting the rotation angle of the steering plate 3 is provided between the steering plate 3 and the frame 13, so as to prevent the steering wheel 1 from rotating at an excessive rotating angle, prevent the meshing between the steering gear 11 and the arc-shaped teeth part from failing, and prevent the steering gear 11 from rotating outside the range of the sector gear so as to result in a failure. At the same time, the turning wheel can be prevented from steering at an excessive rotating angle to result in an accident.

The limiting structure comprises a chute 12 and a slider. The slider is provided in the chute 12 slidably. The chute 12 is provided in an arc shape with the rotating center of the steering plate 3 as a circle. The sliding range of the slider can be limited by the chute 12. The structure is simple, stable and reliable. One of the chute 12 and the slider is provided on the frame 13 and the other thereof is provided on the steering plate 3.

Here, the chute 12 is provided on the steering plate 3, and the slider is provided on the frame 13. In this way, it is convenient and quick to process the chute 12 on the steering plate 3, which saves time and labor.

It should be noted that the orientational or positional relationships indicated by the terms described herein such as “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “clockwise”, “counterclockwise” are based on the orientational or positional relationships shown in the drawings only for the convenience of describing the present disclosure and simplifying the description, rather than indicate or imply that the referred devices or elements must have a specific orientation, be constructed and operated in a specific orientation, and therefore should not be construed as limiting the present disclosure. In addition, the terms such as “first”, “second” and “third” are only used for the purpose of description, and cannot be understood as indicating or implying relative importance.

In the description of the present disclosure, it should also be noted that unless otherwise specified and defined expressly, the terms such as “mount”, “link” and “connect” should be understood broadly, for example, it can be fixed connection, detachable connection or integral connection; or mechanical connection or electrical connection; or direct connection or indirect connection through an intermediate medium. For those skilled in the art, the specific meanings of the above terms in the present disclosure can be understood according to specific situations.

The above only describes the specific embodiments of the present disclosure, but the scope of protection of the present disclosure is not limited thereto. Any changes or substitutions conceivable to those skilled in the art within the technical scope disclosed by the present disclosure should be covered within the scope of protection of the present disclosure. Therefore, the scope of protection of the present disclosure should be based on the scope of protection of the claims.

It can be understood that the same or similar parts in the above embodiments can refer to each other. The contents which are not explained in detail in some embodiments can refer to the same or similar contents in other embodiments. A plurality of schemes provided by the present disclosure include their own basic schemes, which are independent of each other, do not restrict each other, and can also be combined with each other without conflict, so as to achieve a plurality of effects.

Although the embodiments of the present disclosure have been shown and described above, it is to be understood that the above embodiments are illustrative and should not be construed as limitations of the present disclosure. Those skilled in the art can make changes, modifications, substitutions and variations to the above embodiments within the scope of the present disclosure.

What is claimed is:

1. A steering mechanism of a riding lawn mower, comprising:
a steering shaft (2), one end of which is connected with the steering wheel (1), and the other end of which is rotatably connected with the frame (13), wherein a steering gear (11) is coaxially provided;
a steering plate (3), which is rotatably connected to the frame (13), wherein the steering plate (3) is provided with an arc-shaped tooth part engaged with the steering gear (11), and the center of a circle of the arc-shaped tooth part is located at the rotating center of the steering plate (3);
a first steering knuckle (6) and a second steering knuckle (10), which are rotatably connected to the frame (13) and rotate synchronously with respect to the frame (13) through a linkage structure;
a steering knuckle arm (5), which is connected with the first steering knuckle (6) and rotates synchronously with respect to the frame (13);
a connecting rod (4), one end of which is hinged with one end of the steering plate (3) far away from the arc-shaped tooth part, and the other end of which is hinged with the rotating distal end of the steering knuckle arm (5).

2. The steering mechanism of the riding lawn mower according to claim 1, wherein the linkage structure comprises:
a first linkage arm (7), which is connected with the first steering knuckle (6) and rotates synchronously with respect to the frame (13);
a second linkage arm (9), which is connected with the second steering knuckle (10) and rotates synchronously with respect to the frame (13);
a tie rod (8), both ends of which are hinged with the rotating distal ends of the first linkage arm (7) and the second linkage arm (9), respectively.

3. The steering mechanism of the riding lawn mower according to claim 2, wherein the frame (13) is provided with a first steering sleeve and a second steering sleeve, the first steering knuckle (6) is rotatably connected to the first steering sleeve through a first rotating shaft, and the second steering knuckle (10) is rotatably connected to the second steering sleeve through a second rotating shaft.

4. The steering mechanism of the riding lawn mower according to claim 3, wherein the steering knuckle arm (5) and the first linkage arm (7) are both connected with the first rotating shaft and are located at both ends of the first steering sleeve, respectively.

5. The steering mechanism of the riding lawn mower according to claim 1, wherein the steering shaft (2) is obliquely provided with respect to the plane where the steering plate (3) is located, and the steering gear (11) is provided as a helical gear.

6. The steering mechanism of the riding lawn mower according to claim 5, wherein the steering gear (11) is provided as a spiral cylindrical gear, and the arc-shaped tooth part is provided as an involute gear.

7. The steering mechanism of the riding lawn mower according to claim 1, wherein a limiting structure for limiting the rotation angle of the steering plate (3) is provided between the steering plate (3) and the frame (13).

8. The steering mechanism of the riding lawn mower according to claim 7, wherein the limiting structure comprises a chute (12) and a slider provided in the chute (12) slidably, one of the chute (12) and the slider is provided on the frame (13) and the other thereof is provided on the steering plate (3), and the chute (12) is provided in an arc shape with the rotating center of the steering plate (3) as a circle.

9. The steering mechanism of the riding lawn mower according to claim 1, wherein the steering gear (11) is mounted on the frame (13) through a pressing plate (14).

10. The steering mechanism of the riding lawn mower according to claim 2, wherein both ends of the tie rod (8) are connected with the first linkage arm (7) and the second linkage arm (9) through a ball connection structure.
